(19) United States
(12) Patent Application Publication
(10) Pub. No.: US 2018/0195263 A1
(43) Pub. Date: Jul. 12, 2018

(54) METHOD AND SYSTEM FOR ENCAPSULATING A ROTATING BIOLOGICAL CONTACTOR

(71) Applicant: INTERSTATE WATER & WASTEWATER SPECIALISTS, LLC, Manchester, NH (US)

(72) Inventors: Robert CHERVINCKY, Windham, NH (US); Mark CHERVINCKY, Goffstown, NH (US)

(21) Appl. No.: 15/399,904

(22) Filed: Jan. 6, 2017

(51) Int. Cl. E03F 5/08; C02F 3/08

(52) U.S. Cl. CPC E03F 5/08; C02F 3/082

(57) ABSTRACT

A system and method for reducing moisture, hazardous gases, and/or odors within a wastewater facility using a rotating biological contactor (RBC). The system and method encloses the rotating biological contactor using a series of upright frame supports and crossbars and a modular cover. An exhaust pipe and blower create a negative pressure within the enclosure to reduce moisture, hazardous gases, and/or odors within a wastewater facility.

### FIELD OF THE DISCLOSURE

The present disclosure relates to rotating biological contactors and, more particularly, to a method of encapsulating or enclosing rotating biological contactors to reduce moisture, hazardous gases, and/or odors in a wastewater facility.

### BACKGROUND OF THE DISCLOSURE

A Rotating Biological Contactor, or RBC, is a secondary biological treatment process used in the treatment of wastewater. The RBC process uses exposure to a biological medium to help remove pollutants from wastewater prior to releasing the treated water to the environment.

RBCs are typically located inside a building or located outside under a hard cover. These buildings are used to protect the RBC from the weather and the elements and to minimize loss of biological activity due to freezing of the media and prevent damage to drive equipment and bearings. Buildings also help to minimize the growth of algae. However, this design makes the interior of these buildings prone to heavy corrosion, dangerous mold, and structural damage due to the high humidity accumulating inside the building. Additionally, turbulence caused by rotation of the RBC system media can cause odors and/or hazardous gases to escape into the surrounding environment making maintenance of the system difficult or even dangerous for workers. Motors and other mechanical parts of the RBC are also prone to corrosion and excessive wear due to the nature of the environment in which the RBC operates caused by continuous agitation of the wastewater by the rotating media.

The system and method of the present disclosure helps to reduce moisture, hazardous gases and/or odors by lowering humidity levels within the buildings where RBCs are located, which prevents stress on HVAC systems, reduces mold accumulating on walls, eliminates building structural damage due to mold and moisture, minimizes equipment corrosion, improves working environment, and reduces system maintenance costs, among other benefits.

### SUMMARY OF THE DISCLOSURE

One aspect of the present disclosure is a method for reducing humidity in a wastewater facility comprising: providing a plurality of upright frame supports configured to fit around a rotating biological contactor installed in a wastewater tank in the wastewater facility, the rotating biological contactor has a first end and a second end; providing a plurality of frame support crossbars to stabilize the plurality of upright frame supports; providing a tie down bar that is positioned along the perimeter of the wastewater tank; attaching a pair of cover end pieces to the upright frame support positioned at the first end and at the second end of the rotating biological contactor; attaching a cover main piece to the tie down bar positioned on a first side and on a second side of the wastewater tank to create an enclosed system around the rotating biological contactor; venting moisture, hazardous gases, and/or odors from the enclosed system to the external environment via an exhaust pipe; and providing a blower attached to the exhaust pipe to create negative pressure inside the enclosed system thereby reducing the humidity in a wastewater facility.

One embodiment of the method is wherein the pair of cover end pieces comprises vinyl and the cover main piece comprises vinyl. In some cases, the cover main piece further comprises an access cover.

In certain embodiments, the plurality of upright frame supports and the plurality of frame support crossbars are comprised of stainless steel tubing.

In another embodiment, the method further comprises providing a drawstring positioned along the circumference of the upright frame support located at the first end and the second end of the rotating biological contactor. In other cases, the method further comprises providing an adjustable air inlet for the enclosed system to modulate the flow of air through the rotating biological contactor.

Another aspect of the preset disclosure is a system for reducing humidity in a wastewater facility comprising a plurality of upright frame supports configured to fit around a rotating biological contactor installed in a wastewater tank in the wastewater facility, the rotating biological contactor has a first end and a second end; a plurality of frame support crossbars to stabilize the plurality of upright frame supports; a tie down bar that is positioned along the perimeter of the wastewater tank; a pair of cover end pieces attached to the upright frame support positioned at the first end and at the second end of the rotating biological contactor; a cover main piece attached to the tie down bar positioned on a first side and on a second side of the wastewater tank to create an enclosed system around the rotating biological contactor; an exhaust pipe for venting moisture, hazardous gases, and/or odors from the enclosed system to the external environment; and a blower attached to the exhaust pipe to create negative pressure inside the enclosed system thereby reducing the humidity in a wastewater facility.

One embodiment of the system is wherein the pair of cover end pieces comprises vinyl and the cover main piece comprises vinyl. In some cases, the cover main piece further comprises an access cover.

Another embodiment of the system is wherein the plurality of upright frame supports and the plurality of frame support crossbars are comprised of stainless steel tubing.

Yet another embodiment of the system further comprises a drawstring positioned along the circumference of the upright frame support located at the first end and the second end of the rotating biological contactor for sealing the enclosed system.

In certain embodiments, the system further comprises an adjustable air inlet for the enclosed system to modulate the flow of air through the rotating biological contactor.

Yet another aspect of the present disclosure is a system for protecting a rotating biological contactor comprising a plurality of upright frame supports configured to fit around a rotating biological contactor installed in a wastewater tank in the wastewater facility, the rotating biological contactor has a first end and a second end; a plurality of frame support crossbars to stabilize the plurality of upright frame supports; a tie down bar that is positioned along the perimeter of the wastewater tank; a pair of cover end pieces attached to the upright frame support positioned at the first end and at the second end of the rotating biological contactor; and a cover main piece attached to the tie down bar positioned on a first side and on a second side of the wastewater tank to create an enclosed system around the rotating biological contactor.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1A shows a schematic side view of an exemplary rotating biological contactor.

FIG. 1B shows a schematic front view of the exemplary rotating biological contactor of FIG. 1A.

FIG. 2 shows a perspective view of an RBC according to the prior art.

FIG. 3A shows a partial cut-away perspective view of one embodiment of the system of the present disclosure.

FIG. 3B shows a close up representation of a splash guard of one embodiment of the system of the present disclosure.

FIG. 4A shows a perspective view of a frame support according to one embodiment of the system of the present disclosure.

FIG. 4B shows a perspective view of an end piece of a cover installed on a frame support according to one embodiment of the system of the present disclosure.

FIG. 4C shows a perspective view of a main piece of a cover installed on a frame support according to one embodiment of the system of the present disclosure.

FIG. 4D shows a perspective view of one embodiment of a cover for a rotating biological contactor according to the principles of the present disclosure.

FIG. 5 shows a perspective view of several RBCs at a single location according to the prior art.

### DETAILED DESCRIPTION OF THE DISCLOSURE

An RBC comprises a series of circular lightweight rotating discs mounted on a shaft through which wastewater flows. The disks are partially submerged in wastewater and rotate slowly through that wastewater. The disks are typically made of high-density plastic sheets and are usually ridged, corrugated, or lattice-like to increase the surface area used to grow bacteria. The surface of the disks provides an attachment site for bacteria and as the discs rotate within the wastewater, a biofilm grows on the surfaces of the disks. This biofilm is exposed to either the air or the wastewater as the RBC rotates about the shaft.

Organic matter, nutrients, and nitrogen compounds are converted to bacteria (microbes), carbon dioxide, nitrite/nitrate compounds, and water in a two-step process. In the first step, carbonaceous organic matter and nutrients are adsorbed by microbes attached to the plastic media and are converted into additional microbes, carbon dioxide, and water by oxidation. The second step converts oxygen demanding ammonia nitrogen into non-oxygen demanding nitrite/nitrate by the process of nitrification.

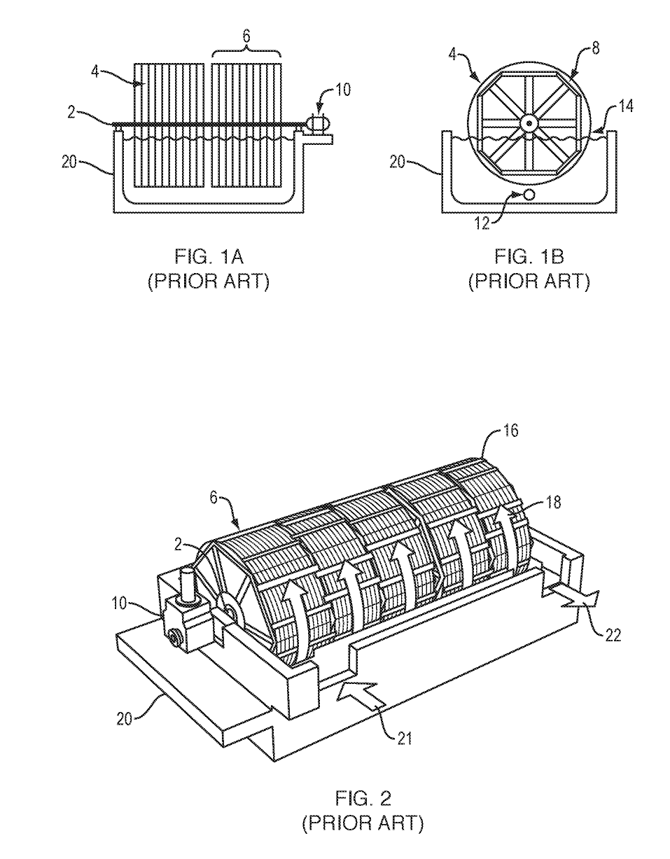

Referring to FIG. 1A and FIG. 1B, schematic side and front views of an exemplary rotating biological contactor (RBC) are shown. More particularly, the RBC has a shaft 2 upon which a plurality of biological media discs, or panels 4, are mounted and sequentially arranged in a spaced relationship along the shaft 2. The media disks, or panels 4, are often assembled into a media pack 6, as diagrammatically shown in FIG. 1A. The media disk, or panel, is supported by a media support 8. There are various styles of media supports, depending on the manufacturer. Some contain the media with structural supports as these drawings show, others insert a singular tube through the center of each media bundle, and others use a type of plastic weld process.

Still referring to FIG. 1A and FIG. 1B, the media packs 6 are typically rotated on the shaft 2 using a motor 10. The two main forms of drives for the operation of the RBC are air drive(s) and mechanical drive(s). In some systems, an optional air inlet 12 is present and is sometimes used to drive the RBC by bubbling air into the wastewater and cups, provided on the perimeter of the disks, capture that air. As the captured air floats up to the surface, this creates rotation of the RBC. In some systems, a combination of both air and mechanical drives are used. RBCs are generally about 35-40% submerged in the wastewater 14. However, it is to be appreciated that for some applications, either more or less submersion of the RBCs may be required or desired.

Referring to FIG. 2, a perspective view of an RBC of the prior art is shown. More specifically, the media packs 6 are rotated on the shaft 2 using a motor 10. There is an inlet for the wastewater to be treated 21 and an outlet for the treated water 22. Optionally, some RBCs have fins 16 on the media pack for scooping up water in one direction and for adding air to the pool of water to be treated. In FIG. 2, a series of circumferential arrows 18 demonstrate the direction of rotation but also show the water treatment progressing from a leading front end (where the wastewater to be treated enters 21) to the trailing back end (where the treated water exits). A reservoir or tank 20 accommodates the wastewater to be treated as well as the RBCs.

Generally, RBCs are used in series, or trains, or in parallel (See, for example, FIG. 5). The typical RBC rotates at a rate of about 1.6 revolutions per minute. By adjusting the speed of rotation or the percent submergence of the RBCs, the efficiency of the pollutant removal can be optimized. Uniform rotation speeds are generally necessary for uniform media growth. Uniform media growth helps to avoid torque loads on the system. As noted above, biological growth attaches to the surface of the media disks and forms a slime layer thereon. The disks rotate through the wastewater and through the air for oxidation as the disk rotates. The rotation of the RBC also helps to shed excess solids.

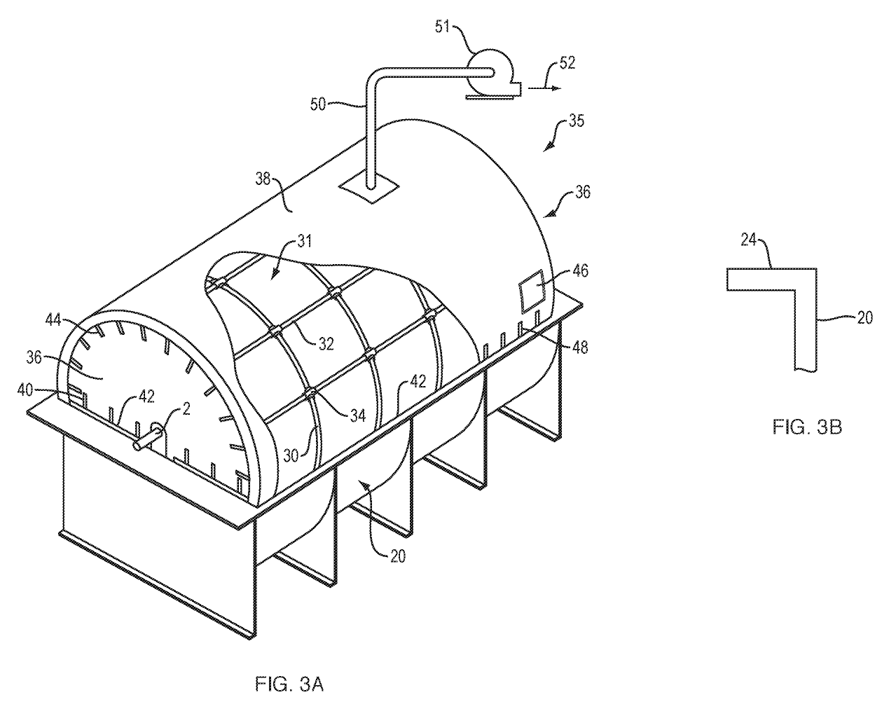

Referring to FIG. 3A, a partial cut-away of one embodiment of the system of the present disclosure is shown. More specifically, one embodiment of the RBC is shown in which the RBC rotates about a shaft 2 in a wastewater tank or reservoir 20. The reservoir or tank 20 can have a splash guard 24 that extends inward towards the RBC from the side wall of the tank 20 (See, for example, FIG. 3B) along the length of the RBC. In some embodiments, drip trays (not shown) are also incorporated which can capture any splashing or condensation from the cover of the present disclosure and redirect it back into the wastewater tank or reservoir 20. This also greatly reduces corrosion of the exterior of the wastewater tank. In some cases, the splash guard 24 can provide a surface for mounting a plurality of upright tube frame supports 30, which are spaced apart along the length of the RBC. The upright tube frame supports 30 are configured to follow generally the circumferential contour or shape of the RBC, and can be sized according to the dimension of the particular RBC. Tube frame crossbars 32 are used to couple adjacent upright tube frame supports 30 and thereby stabilize a frame support 31. The tube frame crossbars 32 and upright tube frame supports 30 are typically joined together using conventional quick disconnect fittings 34 to facilitate installation as well as disassembly of the frame support 31 for major maintenance projects on the RBC. In certain embodiments, the frame support 31 comprises stainless steel from the 300 series. In some cases, galvanized steel, black iron, plastic, or the like may be used. In some cases, the frame support 31 is made up of hollow tubes to provide strength at a lighter overall weight. It is understood that the frame support 31 of the present disclosure comprises components that can be assembled on site and can all easily fit through a standard door frame.

Still referring to FIG. 3A, once the frame support 31 is installed over the RBC, a cover 35 is installed over the frame support. The cover 35 is typically made up of three sections or pieces: a main piece 38 and two end pieces 36. For interior applications, the cover 35 may be made of clear, double-polished 40 gauge vinyl; water-proof, tear resistant polyethylene, and the like, while for exterior applications the cover may be made of 12 mil reflective polyethylene designed to provide UV resistance and reflectivity (e.g., heat resistance). In some examples, the covers are constructed of heavy-duty materials having rope-reinforced hems all around. In some cases, the cover 35 is clear to provide workers with the ability to view and monitor the system without opening the cover.

The cover 35 is secured over the frame support 31 using a variety of different methods. In one embodiment, a tie down bar 42 is installed along an upper edge or rim of the reservoir or wastewater tank 20, to provide an attachment point for adjustable tie down straps 40, 48 (see FIG. 3A). For some applications, adjustable hook-and-loop straps 44 may be used. In certain embodiments, adjustable tie down straps are used for the base of the cover 35, and hook-and-loop straps are used to secure the perimeter edges of the cover 35 around the each respective end upright frame support 30. The cover 35 is constructed such that each piece (36, 38) can be removed for maintenance and/or cleaning of the RBC in buildings having 12 inch or more clearance between the ceiling and the top of the media. The cover 35 is also constructed so that a tension applied to the cover 35 can be adjusted. In one embodiment, there is an access port 46 which is sized and located to provide access to the interior of the RBC. In some cases, this access port 46 is used for the addition of chemicals, to monitor bacterial growth, to take samples, or the like.

FIG. 3A provides a perspective view of an RBC with a cover 35 of the present disclosure installed over it. It is understood that the reservoir tank 20 with the cover 35 installed creates an interior. The interior is enclosed by the cover 35 and the reservoir tank 20. Still referring to FIG. 3A, an exhaust pipe 50 is used to vent system moisture, hazardous gases, and/or odors from the interior of the RBC to the external environment (typically above the roof line) using a blower 51 to create negative pressure within the interior. In certain embodiments, there are downstream processors for sequestering/treating hazardous gases and/or odors vented by the exhaust pipe 50 from the system. The bearings, gearbox, and motors are located outside the covering to reduce their exposure to high humidity and corrosion. Inlet air is typically uniformly introduced into the enclosure via the air space between the lower edge of the cover (e.g., located 3 inches below the tank top) and the RBC tank top. The air flow rate could be varied, however, relative to building ventilation rates the air flow rate is relatively low therefore, the added cost that would be involved may not warrant modification of the system. In regards to biological system reaction to contained flow through containment, it may provide more efficient treatment. The system described herein has been shown to reduce the building humidity at least to below the dew point such that condensation no longer occurs and workers have expressed that it no longer feels cool and damp.

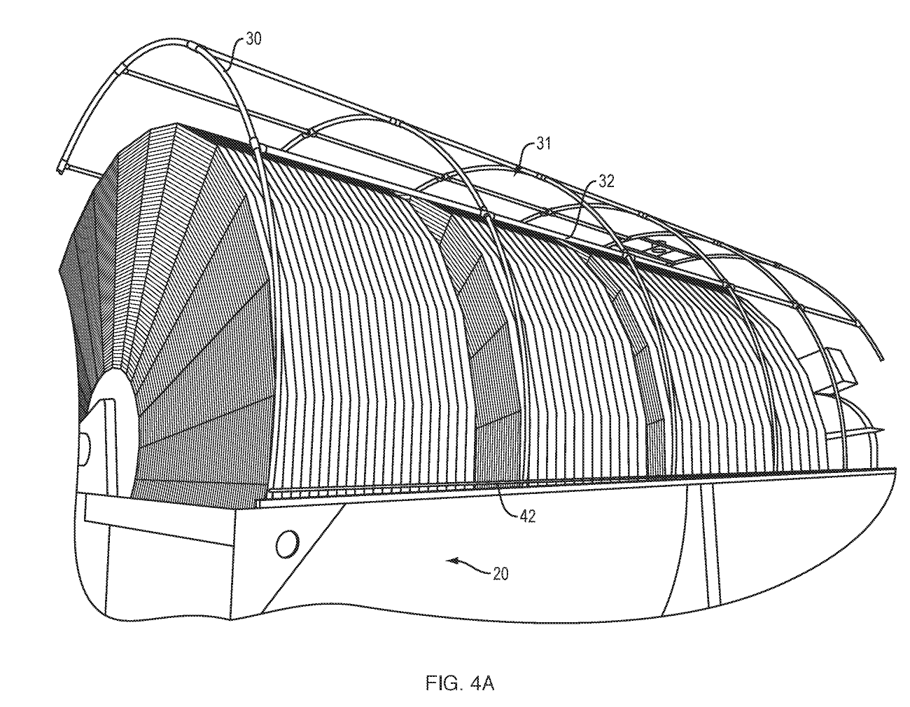

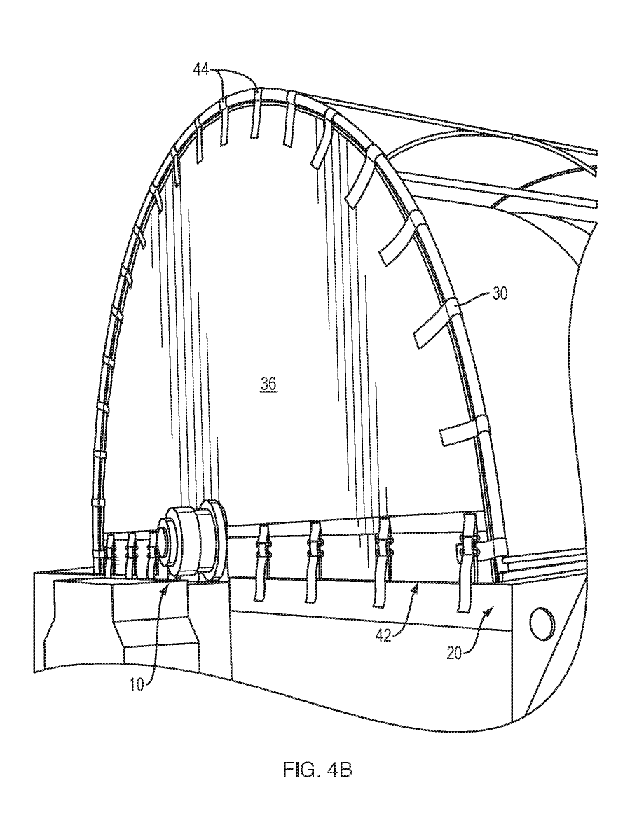

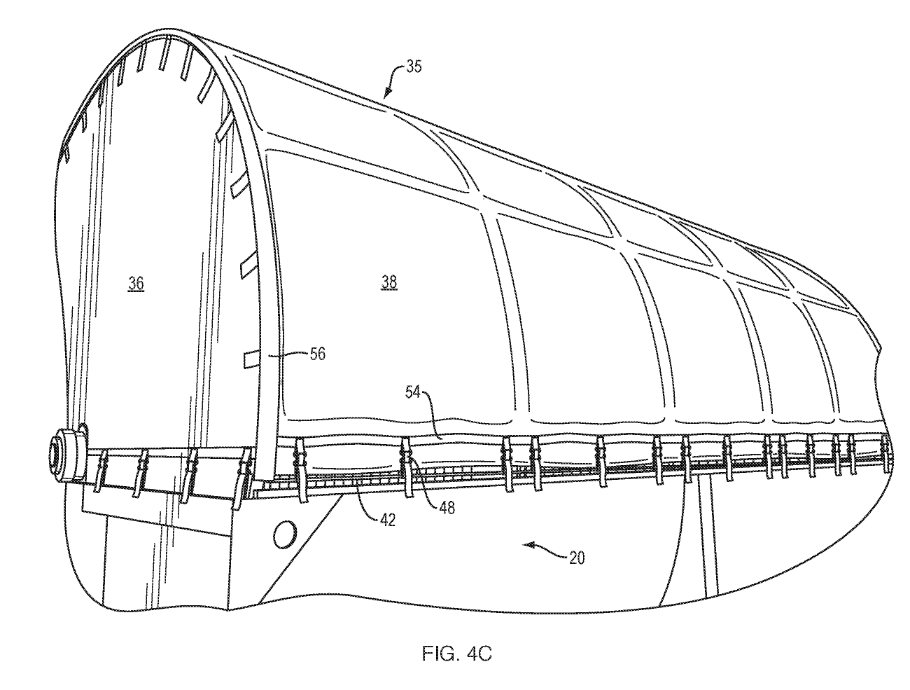

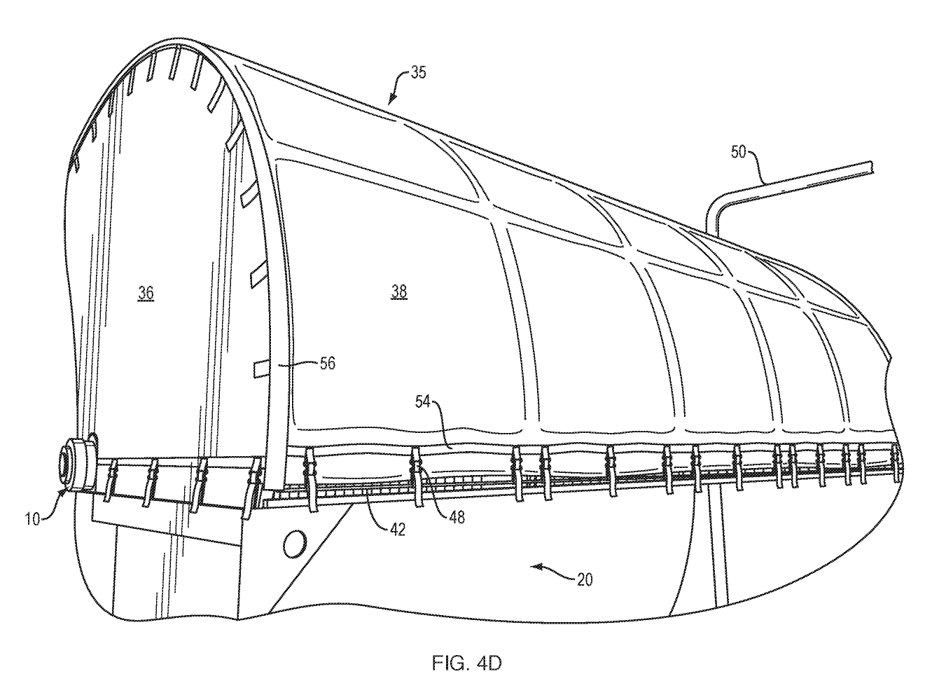

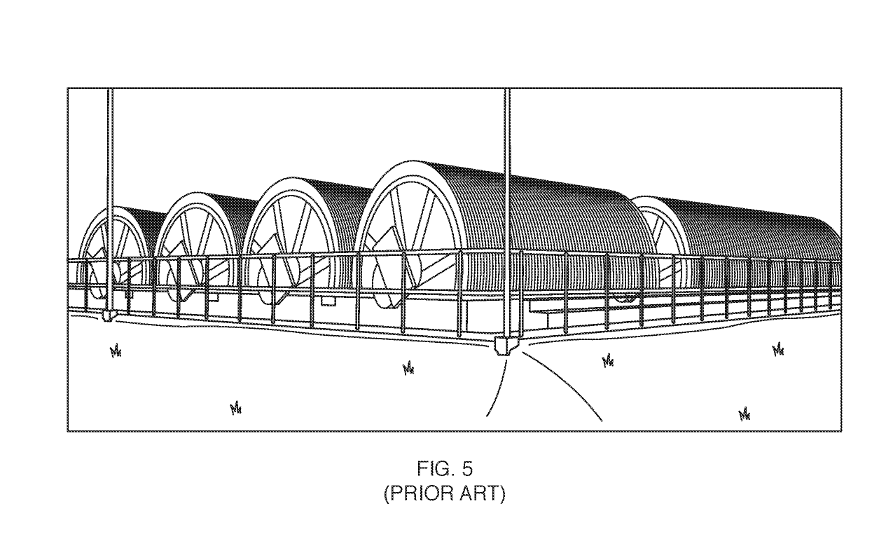

Referring to FIGS. 4A-4D, a series of perspective views show the modularity of the system of the present disclosure and the installation process. More particularly, FIG. 4A shows one embodiment of a frame support 31, comprising upright frames supports 30 and frame support crossbars 32, installed over a RBC. There, a tie down bar 42 is also shown. FIG. 4B shows one example of an end piece 36 secured with hook-and-loop straps 44 to an upright frame support 30 and attached to a tie down bar 42 with adjustable tie down straps 40. FIG. 4B also shows that the motor, gear box, and bearings 10 are on the outside of the cover. FIG. 4C shows a main piece 38 installed over a frame support and secured to a tie down bar 42 using adjustable tie downs 48. In certain embodiments of the end pieces 36 and the main piece 38 of the cover 35, a region 54 where the tie downs and/or straps are attached is reinforced so as to withstand greater tension forces applied to the cover 35 when it is being adjusted. In some cases, a drawstring 56, or the like, extends around the circumference of the frame support at the first end and the second end of the frame support to seal the edge where the end piece 36 and the main piece 38 meet. This can be done using string, cord, or the like, to “draw” or “cinch” the main piece over the end pieces to enclose the system such that it can sustain some amount of negative pressure. In certain embodiments, a cord lock is used to maintain the necessary amount of tension at each end. In certain embodiments, a hook-and-loop mechanism could be used to join the end pieces to the main piece.

Referring to FIG. 4D, a perspective view of one embodiment of a cover for a rotating biological contactor according to the principles of the present disclosure is shown. More particularly, the cover is shown having end pieces 36 (only one of which can be seen) and a main piece 38 that are secured to a frame support 30 and tightened to form a closed system with a RBC accommodated inside the interior. An exhaust pipe 50 is connected to the cover so as to create a vacuum in the system and vent the moisture, hazardous gases, and/or odors out of the building that houses the RBC via a blower (not shown). The inlet air uniformly enters the enclosure around the lower perimeter of the annular space formed between the upper tank wall and a lower edge of the cover which overlaps each other by 3 inches or more in certain embodiments.

In some embodiments of the present disclosure, the cover for a rotating biological contactor can be used instead of heavy existing covers to protect the RBC from the elements. Some advantages of the present cover over the current fiberglass covers used outside are 1) it is easily installed, 2) maintenance friendly since it is somewhat easily removable, and 3) cheaper. The current fiber glass covers are heavy, and require several people to move one section, or the use of a crane. It is understood that exterior RBC's are typically constructed a bit different. For example, a concrete tank is typically utilized, and the unit is built at ground level.

Referring to FIG. 5, a perspective view of several RBCs at a single location is shown. Typical wastewater treatment systems utilize several RBCs in series or in parallel. It is understood that in another embodiment of the present disclosure, multiple RBCs could be covered, as described herein, and the interiors of the several RBCs could be connected in such a way as to remove the moisture, hazardous gases and/or odors from multiple interiors using a single blower. In other cases, multiple blowers might be needed to create the required negative internal pressure in the several interiors.

One aspect of the present disclosure is the system is a cost effective, easily implemented means of covering RBC units placed within a building to prevent corrosion, mold, equipment and building structural damage, and to improve environmental working conditions by eliminating odors, dangerous gases, excessive moisture, and biological growth on building walls, ceilings, floors and equipment.

One embodiment of the system eliminates problems associated with excessive moisture, dangerous gases, and odors resulting from operation of an RBC within a building enclosure by preventing escape into the building proper and venting directly to the atmosphere with or without treatment for odors and/or gases.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed:

1. A method for reducing humidity in a wastewater facility comprising:
providing a plurality of upright frame supports configured to fit around a rotating biological contactor installed in a wastewater tank in the wastewater facility, the rotating biological contactor has a first end and a second end;
providing a plurality of frame support crossbars to stabilize the plurality of upright frame supports;
providing a tie down bar that is positioned along the perimeter of the wastewater tank;
attaching a pair of cover end pieces to the upright frame support positioned at the first end and at the second end of the rotating biological contactor;
attaching a cover main piece to the tie down bar positioned on a first side and on a second side of the wastewater tank to create an enclosed system around the rotating biological contactor;
venting moisture, hazardous gases, and/or odors from the enclosed system to the external environment via an exhaust pipe; and
providing a blower attached to the exhaust pipe to create negative pressure inside the enclosed system thereby reducing the humidity in a wastewater facility.

2. The method of claim 1, wherein the pair of cover end pieces comprise vinyl.

3. The method of claim 1, wherein the cover main piece comprises vinyl.

4. The method of claim 1, wherein the plurality of upright frame supports and the plurality of frame support crossbars are comprised of stainless steel tubing.

5. The method of claim 1, wherein the cover main piece further comprises an access cover.

6. The method of claim 1, further comprising providing a drawstring positioned along the circumference of the upright frame support located at the first end and the second end of the rotating biological contactor.

7. The method of claim 1, further comprising providing an adjustable air inlet for the enclosed system to modulate the flow of air through the rotating biological contactor.

8. A system for reducing humidity in a wastewater facility comprising
a plurality of upright frame supports configured to fit around a rotating biological contactor installed in a wastewater tank in the wastewater facility, the rotating biological contactor has a first end and a second end;
a plurality of frame support crossbars to stabilize the plurality of upright frame supports;
a tie down bar that is positioned along the perimeter of the wastewater tank;
a pair of cover end pieces attached to the upright frame support positioned at the first end and at the second end of the rotating biological contactor;
a cover main piece attached to the tie down bar positioned on a first side and on a second side of the wastewater tank to create an enclosed system around the rotating biological contactor;
an exhaust pipe for venting moisture, hazardous gases, and/or odors from the enclosed system to the external environment; and
a blower attached to the exhaust pipe to create negative pressure inside the enclosed system thereby reducing the humidity in a wastewater facility.

9. The system of claim 8, wherein the pair of cover end pieces comprise vinyl.

10. The system of claim 8, wherein the cover main piece comprises vinyl.

11. The system of claim 8, wherein the plurality of upright frame supports and the plurality of frame support crossbars are comprised of stainless steel tubing.

12. The system of claim 8, wherein the cover main piece further comprises an access cover.

13. The system of claim 8, further comprising a drawstring positioned along the circumference of the upright frame support located at the first end and the second end of the rotating biological contactor for sealing the enclosed system.

14. The system of claim 8, further comprising an adjustable air inlet for the enclosed system to modulate the flow of air through the rotating biological contactor.

15. A system for protecting a rotating biological contactor comprising
a plurality of upright frame supports configured to fit around a rotating biological contactor installed in a wastewater tank in the wastewater facility, the rotating biological contactor has a first end and a second end;
a plurality of frame support crossbars to stabilize the plurality of upright frame supports;
a tie down bar that is positioned along the perimeter of the wastewater tank;
a pair of cover end pieces attached to the upright frame support positioned at the first end and at the second end of the rotating biological contactor; and
a cover main piece attached to the tie down bar positioned on a first side and on a second side of the wastewater tank to create an enclosed system around the rotating biological contactor.
